(19) United States
(12) Patent Application Publication
(10) Pub. No.: US 2016/0063409 A1
(43) Pub. Date: Mar. 3, 2016

(54) SANKEY ASSISTED BUSINESS OPPORTUNITY TASK ASSIGNMENT IN A CUSTOMER RELATIONSHIP MANAGEMENT (CRM) SOLUTION

(71) Applicant: SugarCRM Inc., Cupertino, CA (US)

(72) Inventors: Matthew Marum, Cary, NC (US); Henry Rogers, Raleigh, NC (US)

(21) Appl. No.: 14/469,534

(22) Filed: Aug. 26, 2014

(51) Int. Cl. G06Q 10/06; G06Q 30/00

(52) U.S. Cl. CPC G06Q 10/06311; G06Q 30/01

(57) ABSTRACT

A method for Sankey assisted business opportunity task management in a customer relationship management (CRM) solution includes generating a Sankey visualization of different Sankey flows from business opportunity type to different sales representatives through intermediate stages of a sales cycle. The method also includes displaying the generated Sankey visualization in a triage portion of a user interface for the CRM solution. The method yet further includes selecting a new business opportunity through a new business opportunity portion of the user interface for the CRM solution, and further selecting a particular one of the sales representatives through the triage portion of the user interface of the CRM solution. Finally, the method includes responding to the selection of the particular one of the sales representatives by assigning in the CRM solution the particular one of the sales representatives to one or more tasks corresponding to the selected new business opportunity.

### BACKGROUND OF THE INVENTION

1. Field of the Invention

The present invention relates to business opportunity management in a customer relationship management (CRM) computer program and more particularly to owner assignment for business opportunity tasks in a CRM system.

2. Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

Central to a CRM solution is the notion of a “business opportunity”. A business opportunity in the context of CRM is synonymous with a “sales opportunity” as an element of the “sales pipeline”. A sales pipeline describes an approach to selling, founded on the underlying principles of the sales process. More particularly, the sales pipeline describes the individual steps salespeople undertake from initial contact with a potential customer, or “prospect”, to qualifying that prospect into a lead, and further validating that lead into a sales opportunity followed through the different stages until closed. All sales opportunities arranged along each of the sales steps that make up the sales process represented by the sales pipeline. Thus, a business opportunity is a qualified and validated lead for a potential sale of a product or service.

Within an organization that implements a CRM solution, generally several sales persons supervised by a sales manager manage the sales pipeline. The performance of each individual sales person can be evaluated by the sales manager in terms of dollar volume of transactions “closed” by each sales person, the dollar volume of transactions remaining open and pending “closing” (e.g. becoming a sale), and even the dollar volume of transactions that have failed to “close” but that are no longer a possibility to close. These transactions are known as “lost” sales opportunities. Generally, the analysis required to determine each of the foregoing metrics for each sales person is a manually intensive process. Yet, it remains desirable for the sales manager to assign the most important business opportunities to the sales person most likely to close those business opportunities while not overburdening the best performing sales persons with business opportunities likely to close even when handled by a lesser performing sales person.

### BRIEF SUMMARY OF THE INVENTION

Embodiments of the present invention address deficiencies of the art in respect to business opportunity task management in a CRM system and provide a novel and non-obvious method, system and computer program product for Sankey assisted business opportunity task management in a CRM solution. In an embodiment of the invention, a method for Sankey assisted business opportunity task management in a CRM solution includes generating in memory of a host computing system, a Sankey visualization of different Sankey flows from business opportunity type to different sales representatives through intermediate stages of a sales cycle. The method also includes displaying the generated Sankey visualization in a triage portion of a user interface for the CRM solution in a display of a CRM client communicatively accessing the CRM solution from over a data communications network.

The method yet further includes selecting a new business opportunity through a new business opportunity portion of the user interface for the CRM solution, and further selecting a particular one of the sales representatives through the triage portion of the user interface of the CRM solution. Finally, the method includes responding to the selection of the particular one of the sales representatives by assigning in the CRM solution the particular one of the sales representatives to one or more tasks corresponding to the selected new business opportunity.

In one aspect of the embodiment, the method includes additionally filtering the Sankey visualization to include Sankey flows associated only with a particular type of business opportunity. In another aspect of the embodiment, the intermediate stages include closed-won and closed lost stages. Finally, in yet another aspect of the embodiment, a width of each Sankey flow reflects a dollar volume of past business opportunities of a corresponding type of business opportunity.

In another embodiment of the invention, a CRM data processing system is configured for Sankey assisted business opportunity task management. The system includes a host computing system that has at least one computer with memory and at least one processor. The system also includes a CRM solution executing in the memory of the host computing system. Finally, the system includes a Sankey visualization module coupled to the CRM solution. The module includes program code enabled upon execution in the memory of the host computing system to generate in memory of a host computing system, a Sankey visualization of different Sankey flows from business opportunity type to different sales representatives through intermediate stages of a sales cycle, to display the generated Sankey visualization in a triage portion of a user interface for the CRM solution in a display of a CRM client communicatively accessing the CRM solution from over a data communications network, to select a new business opportunity through a new business opportunity portion of the user interface for the CRM solution, and further selecting a particular one of the sales representatives through the triage portion of the user interface of the CRM solution, and to responds to the selection of the particular one of the sales representatives by assigning in the CRM solution the particular one of the sales representatives to one or more tasks corresponding to the selected new business opportunity.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for Sankey assisted business opportunity task management in a CRM solution;

FIG. 2 is a schematic illustration of a CRM data processing system configured for Sankey assisted business opportunity task management; and,

FIG. 3 is a flow chart illustrating a process for Sankey assisted business opportunity task management in a CRM solution.

### DETAILED DESCRIPTION OF THE INVENTION

Embodiments of the invention provide for Sankey assisted business opportunity task management in a CRM solution. In accordance with an embodiment of the invention, sales performance metrics for different business opportunities that are stored in a data store of a CRM solution can be loaded into memory and associated with different sales persons registered with the CRM solution. A Sankey visualization can be generated from the performance metrics to indicate a flow revenue from different business opportunities of the CRM solution to different ones of the sales persons. The Sankey visualization thereafter can be displayed in a user interface for the CRM solution.

In this regard, within the Sankey visualization an intermediate set of shapes can be displayed to individually indicate a different stage of the sales process, for instance open, closed, won, lost, closed-won and closed lost. As such, within the Sankey visualization, a flow can be drawn for each business opportunity passing through a stage of the sales process and terminating with an associated one of the sales persons. The flow can include a width that is commensurate with a dollar volume of those past business opportunities of a corresponding type.

Consequently, the Sankey visualization can quickly indicate individual ones of the sales persons available for assignment to a new task for a business opportunity and individual ones of the sales persons most successful in favorably closing sales. Responsive to a selection of one of a user interface control displayed within the Sankey visualization and associated with a particular sales person, the new task can be assigned to the particular sales person and the Sankey visualization can update to account for the assignment of the new task.

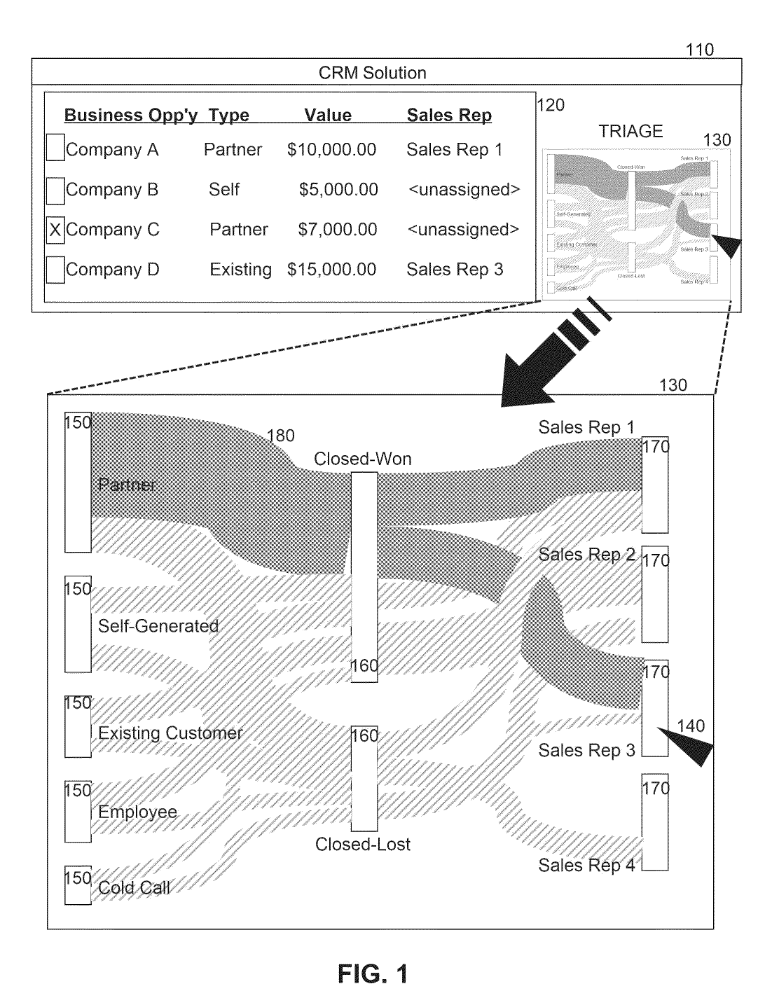

In further illustration, FIG. 1 pictorially shows a process for Sankey assisted business opportunity task management in a CRM solution. As shown in FIG. 1, a CRM solution 110 can include a new business opportunity user interface portion 120 in which a listing is provided of new business opportunities. The listing also can include an indication of a type of business opportunity, a value for the business opportunity and a sales representative assigned to manage one or more tasks corresponding to the business opportunity. The CRM solution 110 also can include a triage user interface portion 130. The triage user interface portion 130 can include a Sankey visualization based upon the metrics of the CRM solution.

In particular, the Sankey visualization can include different flows 180 originating from different types 150 of previously managed business opportunities as managed by the different sales representatives 170 registered in the CRM solution 110. The Sankey visualization also can include an intermediate indication of outcome 160 of those previously managed business opportunities through which the different flows 180 can pass. In this way, a sales manager viewing the Sankey visualization in the triage user interface portion 130 can visualize which of the sales representatives 170 managed which types 150 of the previously managed business opportunities in a closed-won state 160, and which of the sales representatives 170 managed which types 150 of the previously managed business opportunities in a closed-lost state 160.

Abstractly, then, the sales manager considering a selected one of the new business opportunities in the new business opportunity user interface portion 120, can identify a type of the new business opportunity and compare the identified type to different sales representatives 170 in the Sankey visualization of the triage portion of the user interface 130 known to successfully close sales for that type of new business opportunity. Thereafter, the sales manager using pointing device 140 can selected the desired one of the sales representatives 170 in the Sankey visualization so as to assign the selected one of the sales representatives 170 to complete one or more tasks of the selected one of the new business opportunities in the new business opportunity user interface portion 120.

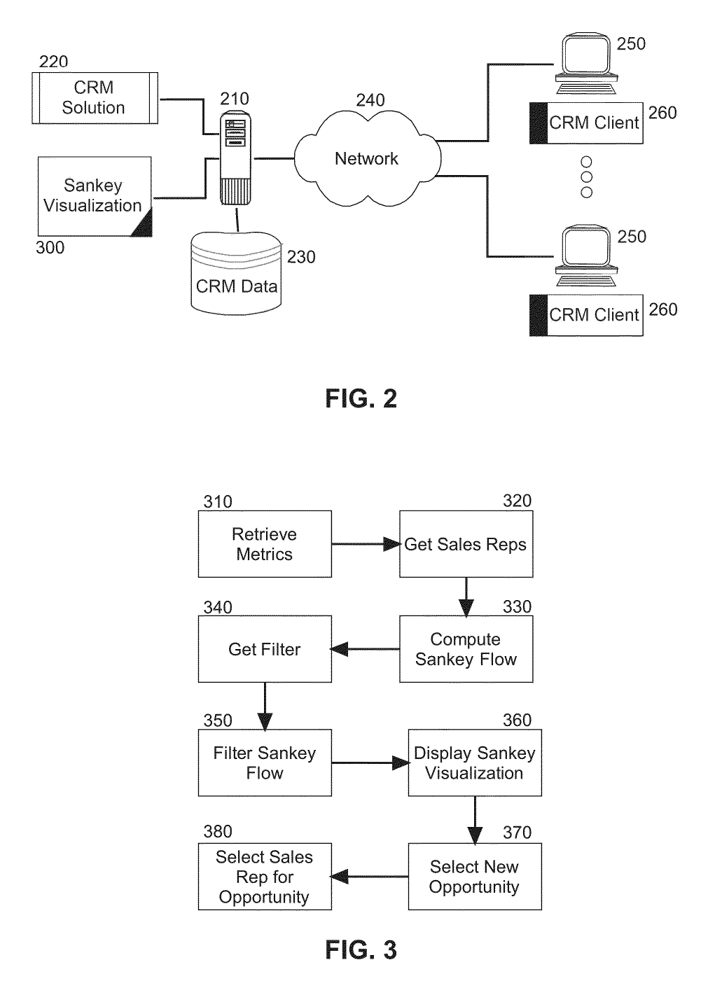

The process described in connection with FIG. 1 can be implemented in a CRM data processing system. In yet further illustration, FIG. 2 schematically shows a CRM data processing system configured for Sankey assisted business opportunity task management. The system can include a host computing system 210 that can include one or more computers, each with memory and at least one processor. The host computing system 210 can support the execution of a CRM solution 220 through which CRM data can be created, managed and updated in a CRM data store 230. In particular, different CRM clients 260 operating in respectively different client computers 250 can access through a CRM user interface (not shown) from over a data communications network 240, the CRM data disposed within the CRM data store 230.

Notably, a Sankey visualization module 300 can be coupled to the CRM solution 220. The Sankey visualization module 300 can include program code that executes in the memory of the host computing system 210. The program code upon execution can be enabled to retrieve CRM metrics from the CRM data store 230 pertaining to past business opportunities, the sales representatives responsible for managing those past business opportunities, the types of business opportunities and the stage in the sales cycle of each of the past business opportunities including whether or not the past business opportunities have closed and whether or not the closed past business opportunities were successfully won resulting in sales or unsuccessfully lost resulting in no sales.

The program code upon execution further can be enabled to generate a Sankey visualization based upon the CRM metrics and the program code can be enabled to display the Sankey visualization in a portion of a user interface of the CRM solution 220 such that different end users accessing the CRM solution 220 from over the data communications network 240 can view the Sankey visualization from with the respectively different CRM clients 260. Optionally, the program code upon execution even further can be enabled to filter the CRM metrics included in the Sankey visualization to include metrics only for a particular type of business opportunity. Finally, the program code upon execution even further can be enabled to allow an end user to select one of the sales representatives in the Sankey visualization so as to create an assignment of an already selected new business opportunity to the selected one of the sales representatives.

In even yet further illustration of the operation of the Sankey visualization module 300, FIG. 3 is a flow chart illustrating a process for Sankey assisted business opportunity task management in a CRM solution. Beginning in block 310, CRM metrics for the CRM solution can be retrieved into memory of the host computing system and in block 320, different sales representatives associated with the management of different past business opportunities in various stages of the sales cycle can be retrieved. In block 330, a Sankey flow can be computed for each business opportunity of each business opportunity type that is closed and either won or lost. In block 340, filter criteria can be chosen so as to filter the Sankey flows to a particular business opportunity type in block 350. Thereafter, a Sankey visualization of the Sankey flows can be displayed in a triage portion of a user interface to the CRM solution. Subsequently, in block 370 a new business opportunity can be selected and in block 380 a sales representative displayed in the Sankey visualization can be selected for assignment to the selected new business opportunity.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for Sankey assisted business opportunity task management in a customer relationship management (CRM) solution, the method comprising
generating in memory of a host computing system, a Sankey visualization of different Sankey flows from business opportunity type to different sales representatives through intermediate stages of a sales cycle;
displaying the generated Sankey visualization in a triage portion of a user interface for the CRM solution in a display of a CRM client communicatively accessing the CRM solution from over a data communications network;
selecting a new business opportunity through a new business opportunity portion of the user interface for the CRM solution, and further selecting a particular one of the sales representatives through the triage portion of the user interface of the CRM solution; and,
responsive to the selection of the particular one of the sales representatives, assigning in the CRM solution the particular one of the sales representatives to one or more tasks corresponding to the selected new business opportunity.

2. The method of claim 1, further comprising filtering the Sankey visualization to include Sankey flows associated only with a particular type of business opportunity.

3. The method of claim 1, wherein the intermediate stages comprise closed-won and closed lost stages.

4. The method of claim 1, wherein a width of each Sankey flow reflects a dollar volume of past business opportunities of a corresponding type of business opportunity.

5. A customer relationship management (CRM) data processing system configured for Sankey assisted business opportunity task management, the system comprising:
a host computing system comprising at least one computer with memory and at least one processor;
a CRM solution executing in the memory of the host computing system; and,
a Sankey visualization module coupled to the CRM solution, the module comprising program code enabled upon execution in the memory of the host computing system to generate in memory of a host computing system, a Sankey visualization of different Sankey flows from business opportunity type to different sales representatives through intermediate stages of a sales cycle, to display the generated Sankey visualization in a triage portion of a user interface for the CRM solution in a display of a CRM client communicatively accessing the CRM solution from over a data communications network, to select a new business opportunity through a new business opportunity portion of the user interface for the CRM solution, and further selecting a particular one of the sales representatives through the triage portion of the user interface of the CRM solution, and to responds to the selection of the particular one of the sales representatives by assigning in the CRM solution the particular one of the sales representatives to one or more tasks corresponding to the selected new business opportunity.

6. The system of claim 5, wherein the Sankey visualization module further is enabled to filter the Sankey visualization to include Sankey flows associated only with a particular type of business opportunity.

7. The system of claim 5, wherein the intermediate stages comprise closed-won and closed lost stages.

8. The system of claim 5, wherein a width of each Sankey flow reflects a dollar volume of past business opportunities of a corresponding type of business opportunity.

9. A computer program product for Sankey assisted business opportunity task management in a customer relationship management (CRM) solution, the computer program product comprising a computer readable storage medium having program instructions embodied therewith, the program instructions executable by a device to cause the device to perform a method comprising:
generating in memory of a host computing system by the device, a Sankey visualization of different Sankey flows from business opportunity type to different sales representatives through intermediate stages of a sales cycle;
displaying by the device the generated Sankey visualization in a triage portion of a user interface for the CRM solution in a display of a CRM client communicatively accessing the CRM solution from over a data communications network;
selecting by the device a new business opportunity through a new business opportunity portion of the user interface for the CRM solution, and further selecting a particular one of the sales representatives through the triage portion of the user interface of the CRM solution; and,
responsive to the selection of the particular one of the sales representatives, assigning in the CRM solution by the device the particular one of the sales representatives to one or more tasks corresponding to the selected new business opportunity.

10. The computer program product of claim 9, further comprising filtering by the device the Sankey visualization to include Sankey flows associated only with a particular type of business opportunity.

11. The computer program product of claim 9, wherein the intermediate stages comprise closed-won and closed lost stages.

12. The computer program product of claim 9, wherein a width of each Sankey flow reflects a dollar volume of past business opportunities of a corresponding type of business opportunity.
